(19) United States
(12) Patent Application Publication
(10) Pub. No.: US 2026/0061289 A1
(43) Pub. Date: Mar. 5, 2026

(54) System for Enhancing Golf-Playing Experience with Augmented Reality Eyewear

(71) Applicant: RangEZ, Inc., La Jolia, CA (US)

(72) Inventor: Dustin Charles Sutton, La Jolia, CA (US)

(21) Appl. No.: 19/311,874

(22) Filed: Aug. 27, 2025

Related U.S. Application Data
(60) Provisional application No. 63/732,543, filed on Aug. 27, 2024.
(60) Provisional application No. 63/849,635, filed on Jul. 23, 2025.

(51) Int. Cl. A63B 71/06; A63B 24/00; A63B 102/32; G02B 27/00; G02B 27/01; G06F 3/01; G06F 3/16

(52) U.S. Cl. CPC A63B 71/0622; A63B 24/0062; A63B 71/0616; G02B 27/0093; G02B 27/0176; G02B 27/0179; G06F 3/012; G06F 3/167; A63B 2071/0638; A63B 2071/0666; A63B 2102/32; A63B 2220/12; A63B 2225/20; A63B 2225/50; G02B 2027/0178; G02B 2027/0187

(57) ABSTRACT

A system for enhancing golf-playing experience with augmented reality eyewear includes smart glasses associated with a mobile application. The mobile application acquires information about golf courses through an application programming interface (API) associated with a backend server and provides the information to the smart glasses. The smart glasses, in turn, provide a head-up display (HUD) providing guidance and other aids to the golf player. Using a blend of AR, global positioning system (GPS), and range finding technology to project distances directly onto the lenses, users are provided with an uninterrupted view of their environment while gaining real-time insight into distances.

### RELATED APPLICATION

This application claims priority to U.S. Provisional Patent Application Ser. No. 63/849,635 for “Augmented Reality Golf Eyewear With Integrated Environmental Analytics and Adaptive Performance Feedback,” filed Jul. 23, 2025, and currently co-pending, and also to U.S. Provisional Patent Application Ser. No. 63/732,543 for “Augmented reality golf eyewear with integrated environmental analytics and adaptive performance feedback,” filed Aug. 27, 2024, and currently co-pending. The above-mentioned related applications are incorporated herein by reference.

### FIELD OF THE INVENTION

The present invention pertains generally to augmented reality devices. More specifically, the present invention provides an augmented reality device useful for enhancing the golfing experience by providing real-time, integrated environmental data and adaptive performance feedback directly relevant to gameplay.

### BACKGROUND OF THE INVENTION

Golf is a popular sport with more than 41 million players in the United States, and over 80 million worldwide, who play on tens of thousands of courses. The game involves the use of clubs to strike a ball toward a hole, with the goal of getting the ball into the hole—and then into successive holes until the course is complete—with as few strokes as possible. A player generally has a set of various clubs, and selects a club for each stroke. Many factors, including distance from the hole, wind, hazards on the course, and the unique course layout of each golf course, affect gameplay. This in turn makes it advantageous to assist play through information technology, which can provide course and weather information.

Existing augmented reality solutions in golf primarily offer static information overlays and lack dynamic interaction with real-time environmental factors. Indeed, the manual operation and delayed feedback of existing solutions disrupts the game, results in inconsistent performance, and slows down the pace of play. These traditional systems do not provide the detailed, personalized performance analytics essential for significantly enhancing a golfer's performance under various conditions.

In view of the above, it would be advantageous to provide a hands-free, real-time solution that streamlines data and improves gameplay.

### SUMMARY OF THE INVENTION

Disclosed is an augmented reality system for aiding a golf player. A preferred embodiment of the system includes smart glasses associated with a mobile application. The mobile application acquires information about golf courses through an application programming interface (API) associated with a backend server and provides the information to the smart glasses. The smart glasses, in turn, provide a head-up display (HUD) providing guidance and other aids to the golf player.

A preferred embodiment provides state-of-the-art wearable technology, presented as wearable glasses, designed specifically to enhance and simplify the golfing experience. More particularly, it provides a golf-oriented augmented reality (AR) wearable that integrates real-time analytics that adapt to immediate environmental changes and player performance; comprehensive sensory data, including weather conditions and course topology, to provide actionable insights tailored to each shot; and a learning algorithm that evolves with the player, offering strategies and feedback that improve over time. It is an innovative integration of AR into wearable glasses with golf-specific analytics in mind by offering a tool that enhances player performance through data-driven insights and not only enhances gameplay, but also serves as a unique educational tool, allowing golfers to understand and adapt to environmental variables.

While providing protection from the sun, these technologically advanced glasses utilize a blend of AR, global positioning system (GPS), and range finding technology to project distances directly onto the lenses. This provides users with an uninterrupted view of their environment while gaining real-time insight into distances. Designed to adapt to varying light conditions, the AR eyewear system stands as the pinnacle of golfing fashion intertwined with groundbreaking innovation.

Moreover, the system is user-centric. A user wears them like regular glasses and directs his or her gaze towards the target, and the glasses do the work. They measure the distance and superimpose the relevant data onto the user's view, helping to keep the golfer's mind on the game, reducing distractions and increasing immersion.

A preferred embodiment of the system integrates multiple different technology architectures. It has AR integration at its core, offering an immersive experience that complements the golfer's vision. GPS and range finding are also integrated. These two integrated systems interact to determine exact distances, giving golfers a competitive advantage.

Preferred embodiments of the glasses are built from materials that promise both comfort and durability in order to ensure that golfers can wear them throughout their rounds without discomfort. Ultimately, they provide hands-free, instantaneous delivery of critical data. It is not just a tool; it is a game-changing companion on the golf course.

The AR hardware includes optically optimized AR lenses capable of displaying vivid, context-sensitive information without disrupting the view. Multi-modal sensors embedded within a lightweight, ergonomically designed frame, capturing everything from wind patterns to elevation. An app-based user interface that dynamically adapts based on the player's real-time situational needs and preferences. Advanced machine learning algorithms process inputs from integrated sensors to deliver customized coaching and game strategies. Compatibility with external golf technology allows for a comprehensive view of player performance. Algorithms predict environmental impacts on play with unprecedented accuracy.

An embodiment provides an interactive virtual caddy that offers personalized shot recommendations and club selection advice using AI algorithms, based on the golfer's historical data and real-time course conditions. Advanced swing analysis is integrated and uses sophisticated sensors to analyze swing mechanics, providing feedback on swing speed, angle of attack, and ball trajectory. A smart notification system alerts the golfer about relevant environmental changes, course conditions, and game-related updates.

Gestures and voice commands are used to interact with the glasses, providing hands-free usability during gameplay. AI-powered performance insights use machine learning techniques to provide predictive analytics about game strategies and performance, offering actionable insights. Full social network integrations allow connectivity to social media platforms, enabling users to share game highlights and statistics effortlessly.

Integrated sensors perform comprehensive data acquisition and allow the glasses to provide a real-time adaptive display for enhanced situational awareness. The data integration spans multiple environmental variables including, but not limited to, altitude-specific wind conditions and localized weather patterns.

A feedback system utilizing machine learning refines recommendations based on user response and shot results, continuously improving its effectiveness.

Use of the glasses provides a method for providing real-time, adaptive game assistance via an augmented reality interface, tailored to environmental conditions and personal player data.

The adaptive game assistance includes personal coaching advice derived from AI-based analysis of the player's past performance, metrics, and current game conditions.

A communication system that is integrated within the AR device allows for social interaction and sharing directly from the field, promoting a socially connected golfing experience.

A feedback loop allows golfers to input and receive tailored advice based on specific game situations, continuously refining the system's accuracy and relevance to the player's needs.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a diagram of a preferred embodiment of a system for enhancing golf-playing experience with augmented reality;

FIG. 2 is a perspective view of a pair of smart glasses of a system for enhancing golf-playing experience with augmented reality;

FIG. 3 is a perspective wireframe view of the pair of smart glasses in which the location of internal electronics and batteries is visible;

FIG. 4 is a diagram of system components of the pair of smart glasses;

FIG. 5 illustrates various user-selectable views for a head-up display (HUD) on the smart glasses;

FIG. 6 illustrates an exemplary user interface for a mobile app in which a golf course is selectable for display on the smart glasses;

FIG. 7 illustrates an exemplary user interface for the mobile app for in-game information; and

FIG. 8 is a flowchart illustrating general steps performed during use of the system for enhancing golf-playing experience with augmented reality eyewear.

### DETAILED DESCRIPTION

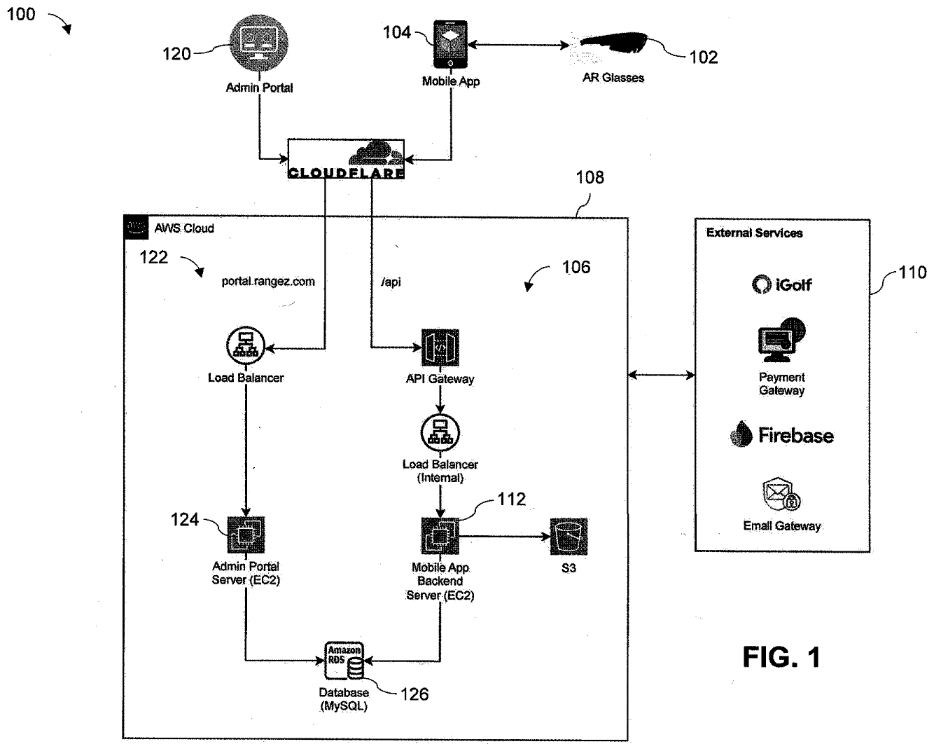

Referring initially to FIG. 1, a system for enhancing a golf-playing experience with augmented reality is illustrated and generally labeled 100. The user experience provided by system 100 centers around augmented reality (AR) eyewear, illustrated by glasses 102. Glasses 102 are in wireless communication with mobile application 104 running on an internet-enabled mobile computing device such as a smartphone. Mobile application 104 uses an application programming interface (API) 106, hosted on a cloud service 108 in preferred embodiments, which in turn accesses external services 110 to provide data through mobile application 104 to glasses 102.

More particularly, glasses 102 provide real-time information to their user about the golf course being played, including distance to the next hole, hazards, simplified maps, suggestions powered by artificial intelligence (AI), and so on. This information is requested by mobile app 104 from mobile app backend 112 through API 106. Mobile App backend generates and provides a response containing the required data to mobile app 104, after obtaining, when necessary, data such as course maps from external services 110.

Preferred embodiments of mobile app backend 112 include an AI model, which in some preferred embodiments runs on specialized compute hardware, such as GPUs or specialized processors; AI-specialized hardware provided through instances from a cloud provider of a type suitable for the computations needed by the AI model allow for scalability during times of high usage, and lower costs when less computational power is needed.

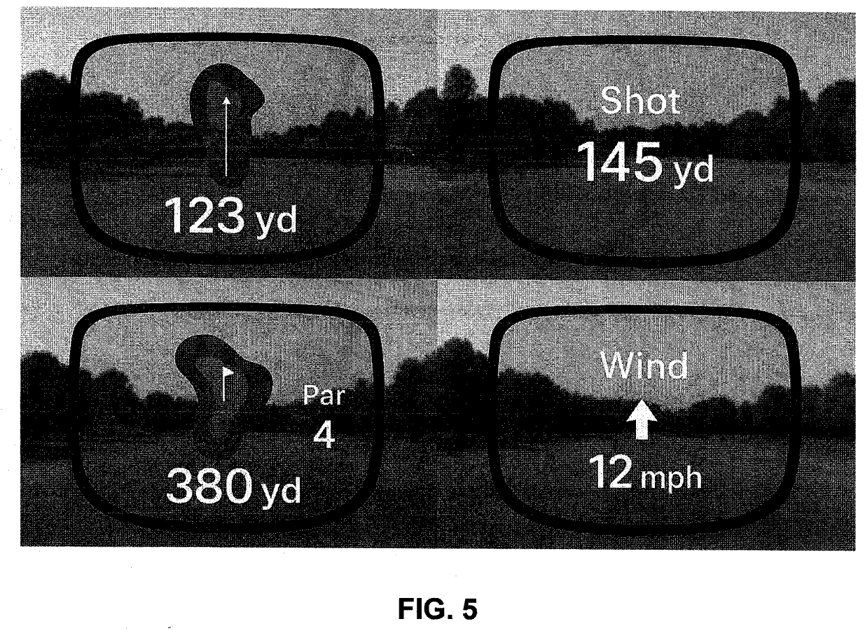

The AI model collects data within the app 104, such as shot history, club usage, and round conditions, and considers it in the context of user-provided information, such as, for example, a user's indication that he or she hits about 175 yards with the 7-iron. The model will contextualize the gathered and user-provided information with course conditions (slope, wind, hazards, etc.) to generate actionable recommendations, for example, advising an 8-iron instead of a 7-iron on a downhill shot. This creates a personalized, adaptive feedback loop unique to each golfer. Feedback is provided directly through the head-up display on glasses 102 (see FIG. 5), or through mobile app 104, depending on user preference.

An admin portal 120 is provided through a website 122 running on an admin portal server 124. Admin portal 120 provides the ability to perform administrative tasks, such as user management, subscription and payment management, course data management, device and AR usage logs, and notification management.

Both admin portal server 124 and mobile app backend 112 are supported by a database 126 containing relevant user account information and collected usage data.

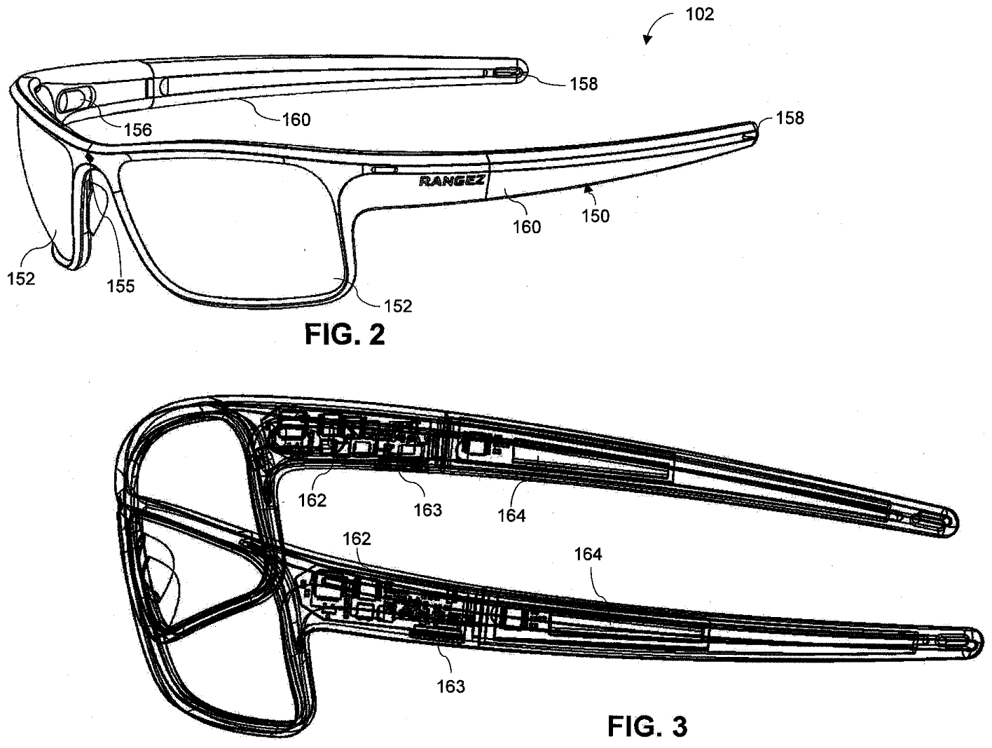

Referring now to FIG. 2, a perspective view of glasses 102 is shown. Preferred embodiments of glasses 102 are sunglasses with an ordinary, fashionable appearance in addition to internal electronics and an on-lens display as described further below.

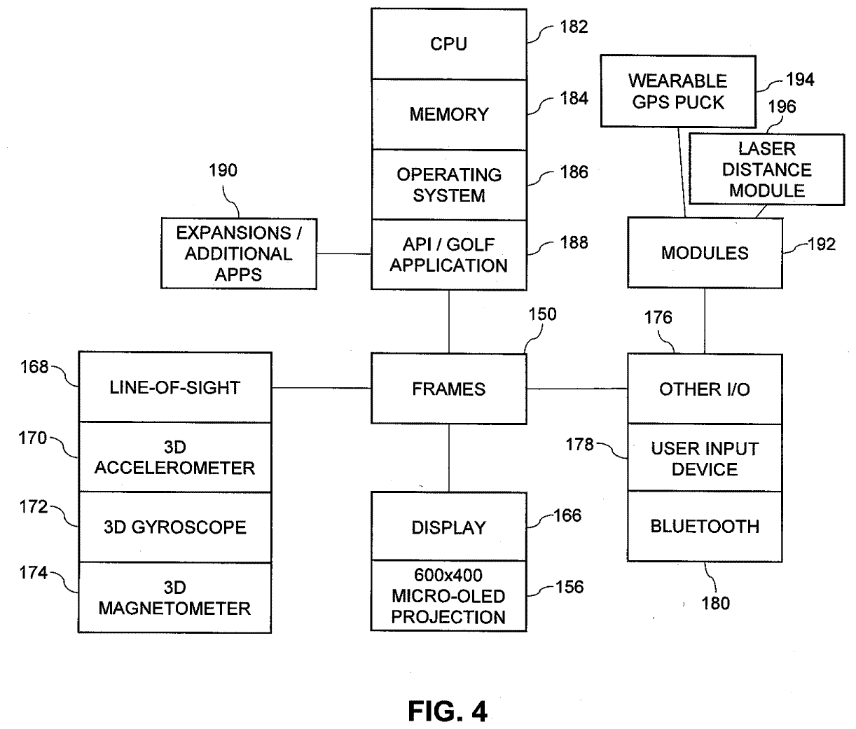

Glasses 102 include frames 150 and lenses 152. As with quality sunglasses in general, preferred embodiments of lenses 152 provide protection from ultraviolet (UV) light for the wearer. In some embodiments, lenses 152 are transition lenses that automatically darken based on the amount of light in the surrounding environment; an exemplary embodiment uses auto-dimming adaptive lenses tuned by light sensors. One or more user input components, such as a touch panel or button 154, are located on frames 150 in preferred embodiments. Some embodiments of glasses 102 include a rangefinder 155 above the nose bridge or on a side of frames 150. Other preferred embodiments do not include an integrated rangefinder 155 for aesthetic or weight reasons, but some support a rangefinder 155 as an external module 192 (see FIG. 4). On the inside of the right (from the wearer's perspective) temple 160 is lens projector 156 for projecting the head-up display (HUD) onto the right (from the wearer's perspective) lens 152. Attachment points 158 are apertures through the end of each temple 160 and allow for the use of accessories with glasses 102.

Referring now to FIG. 3, a wireframe diagram of glasses 102 is illustrated, showing internal components. More particularly, inside temples 160 are electronics 162 supporting the various components described more particularly below in connection with FIG. 4. A preferred embodiment of glasses 102 includes a battery 164 in each temple 160. Located on the bottom of temples 160 are charging connectors 163 that allow glasses 102 to be connected to an external power source to charge batteries 164. Some preferred embodiments use inductive charging, allowing for glasses 102 to be charged simply by being placed in a case (not shown) without the need to directly connect an external power source.

Integrated into frames 150 as a part of electronics 162 in some embodiments are biometric sensors, such as heart rate, oxygen (O₂) saturation, and hydration level sensors.

Referring now to FIG. 4, a component diagram of glasses 102 is shown, illustrating major components of interest. Frames 150 provide a display 166 via projector 156, which is a 600×400 pixel micro-organic light emitting diode (OLED) display in a preferred embodiment.

Line-of-sight (LOS) capabilities 168, to include recognition of head movements such as pitch, yaw, and roll, are provided by head position sensors, including a 3D accelerometer 170, a 3D gyroscope 172, and a 3D magnetometer 174. These features also allow the user to control the glasses through head gestures, such as nodding or looking up, in addition to the other input-output (I/O) interfaces 176.

Other I/O interfaces 176 include one or more user devices 178 and a radio 180. In a preferred embodiment, user devices 178 includes button 154 (shown in FIG. 2). In an alternate embodiment, a touch panel is used and allows the user to provide varied input via swipes and taps on temples 160 (shown in FIG. 2). A preferred embodiment of radio 180 is a Bluetooth radio that provides wireless communication with a mobile phone and other devices, as discussed further below.

The inclusion of other features, such as location services (e.g., GPS or Assisted GPS), is fully contemplated. However, to save space and minimize the weight of glasses 102, a preferred embodiment uses the location services of the mobile phone running the associated mobile phone application, or another connected device such as a smartwatch or external GPS device, with the location information being provided via Bluetooth or other data transfer technology through radio 180 of glasses 102. Indeed, external modules 192 are supported in preferred embodiments, and typically communicate with glasses 102 through radio 180. Exemplary modules include a wearable GPS device 194, such as a clip-mounted GPS device, a pocket device, or a wristband that pairs with glasses 102 to provide GPS services without requiring a phone. Another exemplary module is a laser distance module 196, providing a laser rangefinder for ultra-precise distance measurements, particularly useful in embodiments without a built-in rangefinder 155 (shown in FIG. 2). A directional microphone to enhance course communication or environmental awareness provides an augmented hearing feature, built in to frames 150 in some embodiments, and available as an external module 192 in others.

A central processing unit 182 among electronics 162 (see FIG. 3) causes the above-discussed components to work together as a whole to provide an augmented reality experience to the user. The central processing unit 182 executes instructions in memory 184, providing glasses 102 (see FIG. 2) the ability to run an operating system 186, abstracting the hardware components discussed above for an application layer 188. Application layer 188 includes an application programming interface (API) through which applications access services provided by the operating system 186, enabling them to use I/O 176, line-of-sight 168, and display 166 features. Running on application layer 188 and using the API is the golf application providing the HUD and augmented reality golf experience described herein. Application layer 188 and the API also support running other applications in some preferred embodiments, as discussed in greater detail below.

Expansions, or additional applications 190, can be loaded onto glasses 102 due to the application layer 188 and its API.

Referring now to FIG. 5, some exemplary HUD formats are illustrated. The HUD can display simple graphics and text to indicate information about the course and the current hole, including distance, hole number, score, wind, elevation, and suggestions such as which club to use. In a preferred embodiment the user can switch between different HUD formats presenting different information by tapping button 154 (shown in FIG. 2), or through a gesture, such as a tap, on a touch controller on another preferred embodiment of glasses 102. A forward or backward swipe changes the HUD view to the next or previous hole, respectively. The user can also hide the HUD by tilting his or her head down. Tilting the head up restores the HUD. Other gestures, such as nodding, blinking, or swiping in the air, are recognized by some embodiments to toggle modes or otherwise interact with the app on glasses 102. In addition to button presses, hand gestures, and head gestures, some preferred embodiments are also controllable through voice commands. In preferred embodiments, glasses 102 automatically detect walking and display a minimal version of the HUD, which is restored to the full HUD when the user is stationary again.

HUD layouts are user-configurable through mobile app 104. Within app 104, users can select which data fields they want displayed (e.g., distance to the pin, hazard alerts, shot history, wind direction, or any other available field) and customize the layout to fit their preferences. The configuration is adjustable, so golfers can change their HUD before or even during a round. This allows for both simple displays (e.g., just yardage and hole number) or data-rich layouts (including AI-powered club suggestions, swing metrics, and advanced stats). Moreover, in some preferred embodiments, the display is changed in response to voice commands. For example, the user may say, “What's my distance?” or “Which club should I use?” The information shown on the HUD would then include a response to the query.

Additional information on the HUD in certain layouts and modes in some embodiments includes gamification elements, such as on-course challenges, scoring streaks, and skill development drills in AR. A virtual coaching mode in some embodiments displays a swing overlay comparing the user's motion against a professional's recorded swing. Synchronized group play is available in some embodiments, and displays a distances and leaderboards for everyone in a group in real time on the HUD.

Exemplary expansions 190 (see FIG. 4) similarly provide HUDs with relevant information for other sports, games, or applications. Exemplary expansions include: A cycling app providing real-time speed, cadence, GPS navigation overlays, and a heart rate display powered by a built-in heart rate monitor or one from an external device such as a smartwatch or chest strap; a running app providing pace per mile, split times, GPS route visualization, and training plan prompts, also including heart rate information in preferred embodiments; a hunting app providing a ballistics calculator, a distance-to-target overlay, and low-light vision assist; a fishing app providing weather/wind overlays, sonar data integration, and catch logging; a team sports app providing a coach mode for football or soccer, including live play diagrams and stats during training. A tournament integration expansion provides a live leaderboard, sponsor ads, and player stats streamed to glasses 102. A training expansion for military and law enforcement provides tactical overlays for navigation, range, and targeting. A resort or course application provides features such as a premium AR tour for purchase by guests.

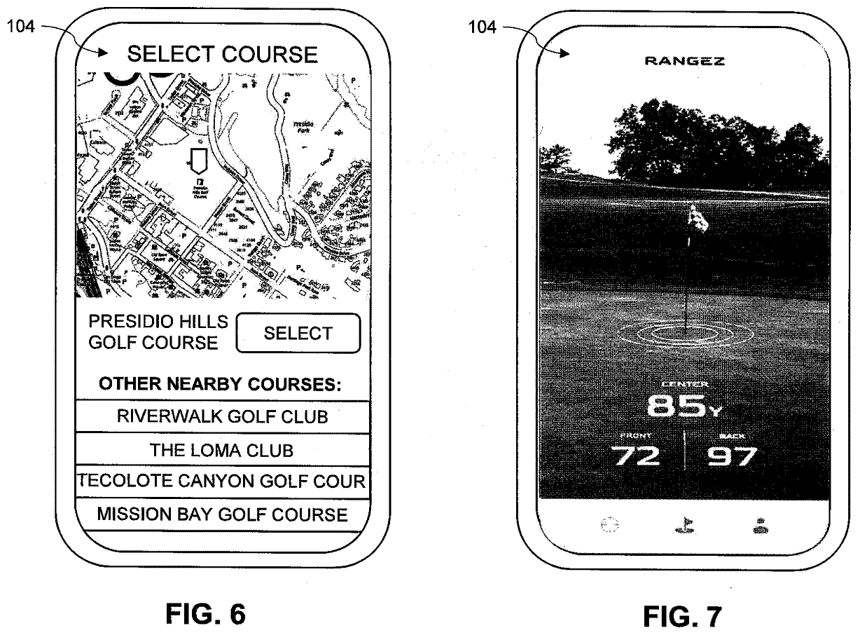

Referring now to FIG. 6, an exemplary portion of a mobile app 104 user interface for a preferred embodiment of a system 100 (see FIG. 1) for enhancing golf-playing experience with augmented reality is illustrated. In preparation for use of glasses 102 (shown in FIG. 2) during a game of golf, the user selects the golf course that the user will play in the mobile app. In a preferred embodiment of the user interface, the app provides a default option based on the user's location. If the default option is not the desired course, the user can select a different course. Data associated with the selected course is then provided to glasses 102 in order to display the appropriate information on the HUD.

Referring now to FIG. 7, an in-game user interface of mobile app 104 is illustrated. The user will generally prefer the hands-free display of information provided by glasses 102 (shown in FIG. 2), but preferred embodiments of mobile app 104 are also capable of displaying course information, including distances from the user, as desired.

Additional functionality in some preferred embodiments of mobile app 104 includes offering swing tips, alternative game formats, and enhanced practice modes, as well as score tracking, social features for sharing rounds with friends, integration with wearables, personalized recommendations based on playing history, and push notifications for weather or course condition updates. Some preferred embodiments include the ability to communicate with the course clubhouse to perform actions such as ordering food, booking carts, and checking the pace of play. An exemplary embodiment also integrates with tournament scoring systems.

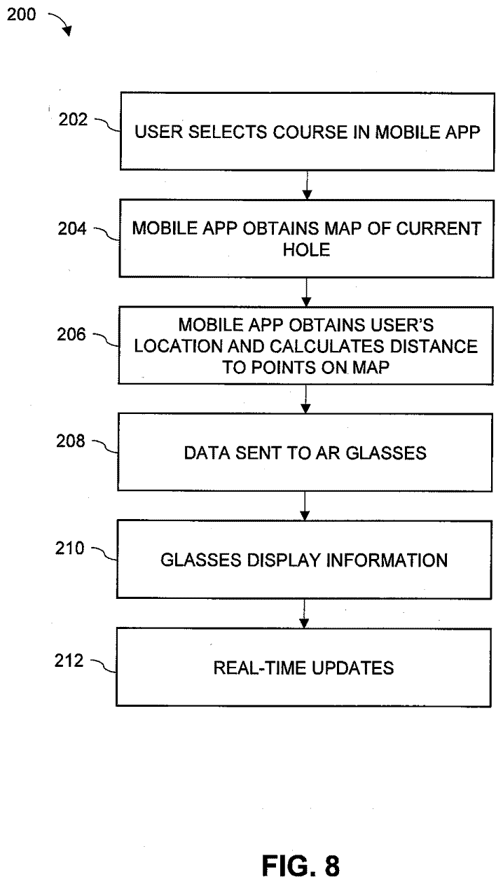

Referring now to FIG. 8, a process 200 for enhancing golf-playing experience with augmented reality eyewear is illustrated to help illuminate the operation of preferred embodiments of the above-described system 100 (illustrated in FIG. 1).

Process 200 begins with step 202, in which the user selects a course in mobile app 104 (shown in FIG. 1; see also FIG. 6). The app 104 obtains the full GPS map of the course from an external service 110 (see FIG. 1), such as iGolf, including hole layouts and the location of greens, hazards, and pins.

In step 204, the app 104 loads the map for the hole that the user is currently playing. The hole is automatically selected based on the user's location, but the user can select another hole through glasses 102 or app 104 if needed or desired. The app 104 knows where everything is, including the tee box, green, bunkers, and water hazards, enabling it to provide complete and accurate information to the user.

In step 206, the app 104 obtains the user's location and calculates the distance to a point or points of interest on the map, such as the hole; the front, center, and back of the green; or any hazard the user chooses. Distances are provided in yards or meters.

In step 208, the data from previous steps is provided to glasses 102. Glasses 102 in turn display information to the user in step 210, such as distances overlaid on the real course, arcs showing 100, 150, and 200 yards, hole number, par, and remaining distance, or other information as desired by the user such as discussed above.

In step 212, steps 204 through 210 are repeated while the app updates the user's position automatically as the player moves. As a result, the glasses refresh the displayed distances and adjust them to match the user's head direction, and the user sees accurate, live information without looking away from the course.

While there have been shown what are presently considered to be preferred embodiments of the present invention, it will be apparent to those skilled in the art that various changes and modifications can be made herein without departing from the scope and spirit of the invention.

What is claimed is:

1. A system for enhancing golf-playing experience, comprising:
augmented reality glasses comprising frames having head position sensors and providing a head-up display (HUD);
a mobile application, comprising a network connection, location services, and a user interface; and
a backend server,
wherein the user interface is engageable to select a golf course for play with the augmented reality glasses,
wherein the mobile application responds to selection of a golf course by requesting course data from the backend server, and
wherein the mobile app acquires the user's location through the location services and provides associated hole data to the augmented reality glasses for display on the HUD.

2. The system for enhancing golf-playing experience of claim 1, wherein the augmented reality glasses are configured to hide the HUD in response to a first head movement from the user and restore the HUD in response to a second head movement from the user.

3. The system for enhancing golf-playing experience of claim 2, wherein the first head movement is a nod and the second head movement is looking up.

4. The system for enhancing golf-playing experience of claim 1, wherein the HUD displays information about a current hole being played in the golf course.

5. The system for enhancing golf-playing experience of claim 4, wherein the glasses comprise a user-input device engageable to change which hole is displayed on the HUD.

6. The system for enhancing golf-playing experience of claim 5, wherein the user-input device comprises a button on the frames.

7. The system for enhancing golf-playing experience of claim 5, wherein the user-input device comprises a touch panel on the frames.

8. Augmented reality glasses for golf, comprising:
frames;
ultraviolet (UV) blocking lenses positioned in the frames; and
electronic components within the frames, comprising:
line-of-sight components;
a display;
one or more user input devices;
a wireless input-output (I/O) device;
memory; and
a central processing unit in electronic communication with the line-of-sight components, the display, the one or more user input devices, the wireless I/O device, and the memory,
wherein the central processing unit is configured to:
receive golf course data from a mobile application;
determine a user's position on the golf course;
determine the user's distance to a next hole; and
display a map and distance to the next hole on the display.

9. The augmented reality glasses for golf of claim 8, wherein the one or more user input devices comprises a button on the frames.

10. The augmented reality glasses for golf of claim 8, wherein the one or more user input devices comprises a touch panel on the frames.

11. The augmented reality glasses for golf of claim 8, wherein the one or more user input devices comprises a voice control feature.

12. The augmented reality glasses for golf of claim 8, wherein the frames further comprise a laser rangefinder.

13. The augmented reality glasses for golf of claim 8, wherein the wireless I/O device is configured to communicate with an external module comprising a laser rangefinder.

14. The augmented reality glasses for golf of claim 8, wherein the wireless I/O device is configured to communicate with an external module comprising a wearable GPS device.

15. A system for enhancing golf-playing experience, comprising:
augmented reality (AR) glasses, comprising:
frames,
lenses positioned in the frames, and
electronic components within the frames, comprising:
line-of-sight components;
a display;
one or more user input devices;
a wireless input-output (I/O) device;
memory; and
a central processing unit (CPU) in electronic communication with the line-of-sight components, the display, the one or more user input devices, the wireless I/O device, and the memory;
a mobile application, comprising a network connection, location services, and a user interface; and
a backend server,
wherein the user interface is engageable to select a golf course for play with the AR glasses,
wherein the mobile application responds to selection of a golf course by requesting course data from the backend server,
wherein the mobile app acquires the user's location through the location services and provides associated hole data to the AR glasses, and
wherein the CPU is configured to cause the display to generate a head-up display (HUD) on the lenses that displays information about a current hole being played in the golf course.

16. The system for enhancing golf-playing experience of claim 15, wherein the backend server is configured to analyze user provided data and data collected during gameplay and generate feedback in the form of performance insights for display to a user.

17. The system for enhancing golf-playing experience of claim 16, wherein the performance insights are displayed on the mobile application.

18. The system for enhancing golf-playing experience of claim 16, wherein the performance insights are displayed on the HUD.

19. The system for enhancing golf-playing experience of claim 15, wherein the CPU is further configured to run applications for AR play of one or more sports selected from cycling, running, hunting, and fishing.

20. The system for enhancing golf-playing experience of claim 15, wherein the CPU is further configured to cause the display to show leaderboards for a group of players on the HUD.
